(19) United States
(12) Patent Application Publication
(10) Pub. No.: US 2024/0035817 A1
(43) Pub. Date: Feb. 1, 2024

(54) TIRE INSPECTION APPARATUS, TIRE INSPECTION SYSTEM, AND RECORDING MEDIUM FOR TIRE INSPECTION

(71) Applicant: TOYO TIRE CORPORATION, Itami-shi Hyogo (JP)

(72) Inventors: Yoichi Kawashima, Itami-shi Hyogo (JP); Yuki Ishijima, Itami-shi Hyogo (JP); Akinori Miyake, Itami-shi Hyogo (JP); Masato Furukawa, Itami-shi Hyogo (JP); Hiroaki Sugimoto, Itami-shi Hyogo (JP)

(21) Appl. No.: 18/359,715

(22) Filed: Jul. 26, 2023

(30) Foreign Application Priority Data
Jul. 26, 2022 (JP) 2022-119058

(51) Int. Cl. G01B 21/18; G01M 17/02

(52) U.S. Cl. CPC G01B 21/18; G01M 17/02; G01B 2210/58

(57) ABSTRACT

A tire inspection system includes a data acquisition unit, a user operation acknowledgment unit, and a display processing unit. The data acquisition unit acquires data for groove depth measured by a groove depth measurement instrument for measuring a groove depth of a tire. The user operation acknowledgment unit acknowledges a user operation input provided by a worker to indicate whether an uneven wear is identified in the tire for which the data for groove depth is acquired by the data acquisition unit. The display processing unit displays, when a user operation input acknowledged by the user operation acknowledgment unit indicates that an uneven wear is identified, a schematic diagram corresponding to a plurality of types of uneven wear. The user operation acknowledgment unit acknowledges a user operation input for the worker's selection of a type of uneven wear from the schematic diagram.

### CROSS-REFERENCE TO RELATED APPLICATION

This application is based upon and claims the benefit of priority from the prior Japanese Patent Application No. 2022-119058, filed on Jul. 26, 2022, the entire contents of which are incorporated herein by reference.

### BACKGROUND OF THE INVENTION

### 1. Field of the Invention

The present invention relates to a tire inspection apparatus, a tire inspection system, and a recording medium for tire inspection for inspecting the groove depth and uneven wear of a tire mounted on a vehicle.

### 2. Description of the Related Art

Generally, a tire wears depending on the traveling condition, travel distance, etc. The wear amount varies depending on the axle position at which the tire is mounted. When the depth of a groove provided in a tire becomes equal to or less than a predetermined amount, maintenance such as exchange becomes necessary.

JP 2009-102009 A discloses a related-art uneven tire wear management method. This uneven tire wear management method reads the tire shape by a scanner and compares the read shape with the shape of the same tire presented when it was new. The differential shape resulting from the comparison is used to search an uneven wear DB to determine whether an uneven wear is identified and the type of wear. When all tires of a given vehicle is examined for uneven wear, an instruction for tire position replacement method and for other countermeasures extracted by searching a position replacement database and a countermeasure database are displayed.

### SUMMARY OF THE INVENTION

The uneven tire wear management method disclosed in JP2009-102009 A reads the tire shape by a scanner and searches the uneven wear database to determine whether there is an uneven wear and the type of wear. However, there is a problem in that accurate acquisition of a three-dimensional tire shape over the entire tire circumference using a scanner requires an expensive apparatus and a lot of effort and time.

The present invention addresses the issue described above, and a purpose thereof is to provide a tire inspection system and a tire inspection program capable of conducting an inspection of a condition of uneven wear of a tire efficiently.

A tire inspection system according to an aspect of the present invention includes a data acquisition unit that acquires data for groove depth measured by a groove depth measurement instrument for measuring a groove depth of a tire; a user operation acknowledgment unit that acknowledges an input provided by a worker to indicate whether an uneven wear is identified in the tire for which the data for groove depth is acquired by the data acquisition unit; and a display processing unit that displays, when a user operation input acknowledged by the user operation acknowledgment unit indicates that an uneven wear is identified, a schematic diagram corresponding to a plurality of types of uneven wear, wherein the user operation acknowledgment unit acknowledges a user operation input for the worker's selection of a type of uneven wear from the schematic diagram.

Another aspect of the present invention relates to a tire inspection program. The tire inspection program causes a computer to execute a data acquisition step that acquires data for groove depth measured by a groove depth measurement instrument for measuring a groove depth of a tire; a user operation acknowledgment step that acknowledges a user operation input provided by a worker to indicate whether an uneven wear is identified in the tire for which the data for groove depth is acquired by the data acquisition step; a display processing unit step that displays, when a user operation input acknowledged by the user operation acknowledgment step indicates that an uneven wear is identified, a schematic diagram corresponding to a plurality of types of uneven wear, wherein the user operation acknowledgment step acknowledges a user operation input for the worker's selection of a type of uneven wear from the schematic diagram.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a schematic diagram showing an overall configuration of a tire inspection system according to the embodiment;

FIG. 2 is a block diagram showing a functional configuration of the tire management server apparatus;

FIG. 3 is a block diagram showing a functional configuration of the tire inspection apparatus;

FIG. 4 is a flowchart showing a sequence of steps of a process performed by the tire inspection system to measure the groove depth and uneven wear;

FIG. 5 is a schematic diagram showing an example of axle arrangement information;

FIG. 6 is a schematic diagram showing an exemplary image displayed on the display unit after a groove depth is measured;

FIG. 7 shows an exemplary screen for acknowledging a user operation input indicating whether an uneven wear is identified or not;

FIG. 8 shows an exemplary screen showing a schematic diagram corresponding to a plurality of types of uneven wear;

FIG. 9 shows an exemplary screen shown when heel and toe wear is selected; and

FIG. 10 shows an example of screen display for acquiring stepped wear data.

### DETAILED DESCRIPTION OF THE INVENTION

The invention will now be described by reference to the preferred embodiments. This does not intend to limit the scope of the present invention, but to exemplify the invention.

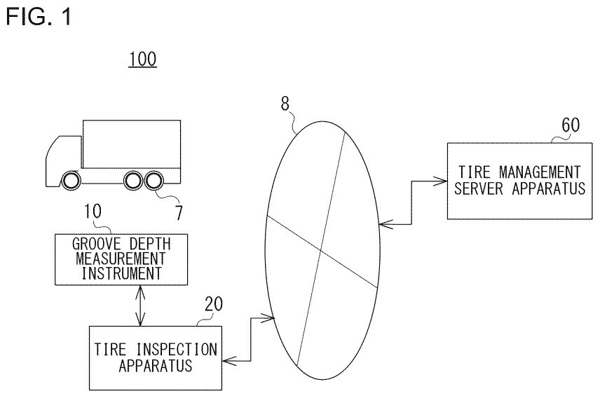

Hereinafter, the invention will be described based on a preferred embodiment with reference to FIGS. 1 through 10. Identical or like constituting elements and members shown in the drawings are represented by identical symbols and a duplicate description will be omitted as appropriate. The dimension of members in the drawings shall be enlarged or reduced as appropriate to facilitate understanding. Those of the members that are not important in describing the embodiment are omitted from the drawings.

### Embodiment

FIG. 1 is a schematic diagram showing an overall configuration of a tire inspection system according to the embodiment. The tire inspection system 100 includes a groove depth measurement instrument 10, a tire inspection apparatus 20, and a tire management server apparatus 60. The tire inspection system 100 acquires data for groove depth and an inspection result related to a condition of uneven wear obtained by inspecting each tire 7 mounted on a plurality of vehicles managed by the tire management server apparatus 60.

The tire inspection apparatus 20 acquires the inspection result related to the condition of uneven wear provided by the worker as well as acquiring information on the tire 7 mounted on the vehicle and acquiring the data for groove depth measured in each tire by the groove depth measurement instrument 10. The tire inspection apparatus 20 transmits the data for groove depth of each tire measured and the inspection result related to the condition of uneven wear to the tire management server apparatus 60. The tire management server apparatus 60 collects the data for groove depth of the tire 7 in each vehicle and the inspection result related to the condition of uneven wear received from the tire inspection apparatus 20.

The tire 7 is mounted on, for example, a plurality of vehicles such as cargo trucks operated under the management of, for example, a transport company. For the plurality of tires 7 mounted on each vehicle, the transport company can acquire tire groove depth data and the inspection result related to the condition of uneven wear collected in the tire management server apparatus 60 and use them for maintenance of the tire.

It will be assumed that the groove depth measurement instrument 10 is, for example, a depth gauge and can transmit measured data through communication. The worker uses the groove depth measurement instrument 10 to measure the groove depth of each groove provided in the tread part of the tire 7 mounted on the vehicle. The groove depth of the tire 7 is repeatedly inspected at an interval of a predetermined period of time (e.g., several months) and collected in the tire management server apparatus 60. Further, the groove depth measurement instrument 10 may measure the depth of each groove of the tire 7 automatically by using a scanner, a stereo camera, etc.

Given that there are four grooves extending in the circumferential direction of the tire in the tread part of the tire, for example, the groove depth of the tire 7 is measured at four locations in the width direction and further measured at three locations in the circumferential direction of the same groove at an interval of, for example, 120°. This makes it possible to acquire data for uneven wear in the width direction or the circumferential direction of the tire.

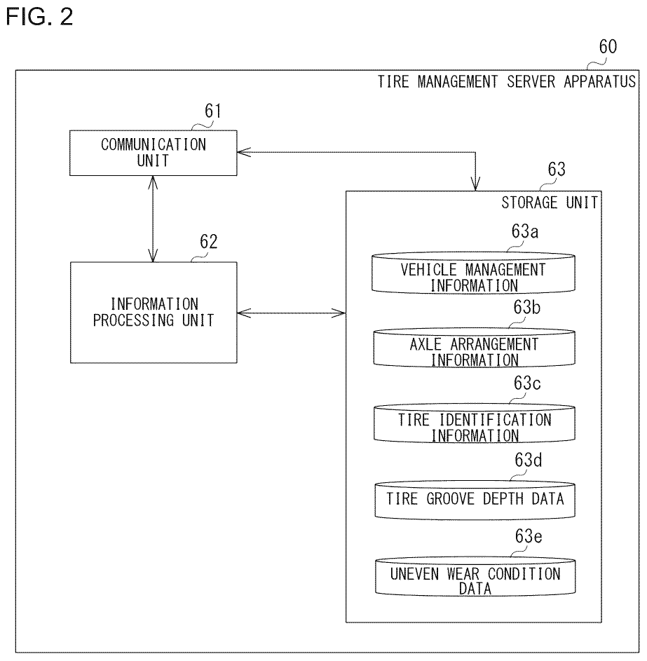

FIG. 2 is a block diagram showing a functional configuration of the tire management server apparatus 60. The tire management server apparatus 60 includes a communication unit 61, an information processing unit 62, and a storage unit 63. The units in the tire management server apparatus 60 can be implemented in hardware such as a processing circuit comprised of an electronic element exemplified by a CPU of a computer and a mechanical component, and in software such as a computer program. FIG. 2 depicts functional blocks implemented by the cooperation of these units. Accordingly, those skilled in the art will understand that these functional blocks can be realized in various forms by a combination of hardware and software.

The communication unit 61 is communicably connected to a communication network 8 by wireless or wired communication and communicates with the tire inspection apparatus 20.

The information processing unit 62 receives a request for transmission of information related to the vehicle and the tire 7 from the tire inspection apparatus 20 via the communication unit 61. The request for transmission of information related to the vehicle and the tire 7 from the tire inspection apparatus 20 includes, for example, identification information on the vehicle. The information processing unit 62 reads, from the storage unit 63, axle arrangement information 63b and tire identification information 63c for the vehicle, etc. identified by the request for transmission and transmits the information thus read to the tire inspection apparatus 20. The information processing unit 62 acquires the data for groove depth of the tire 7 from the tire inspection apparatus 20 via the communication unit 61 and stores and collects it in the storage unit 63 as tire groove depth data 63d. The information processing unit 62 acquires the result of inspection of the condition of uneven wear of the tire 7 from the tire inspection apparatus 20 via the communication unit 61 and stores and collects it in the storage unit 63 as uneven wear condition data 63e.

The storage unit 63 is a storage device comprised of, for example, a solid state drive (SSD), a hard disk, a CD-ROM, a DVD, etc. The storage unit 63 stores vehicle management information 63a, axle arrangement information 63b, tire identification information 63c, tire groove depth data 63d, and uneven wear condition data 63e.

The vehicle management information 63a represents information related to a plurality of vehicles operated under the management of, for example, a transport company and includes the name of the vehicle, identification information on the vehicle assigned to each vehicle, etc. The axle arrangement information 63b represents information corresponding to each vehicle included in the vehicle management information 63a and related to the position of the axle and the tire 7 that is mounted.

The tire identification information 63c represents information such as a serial number assigned to each tire 7. For example, it is assumed that the tire identification information is readably stored in an RFID built in the tire 7. The tire identification information may be stored in the storage unit 63 in association with the vehicle that the tire 7 is mounted on and the position of the axle in the vehicle that the tire 7 is mounted on.

The tire groove depth data 63d represents data for groove depth of each tire 7 transmitted from the tire inspection apparatus 20 and is collected in the storage unit 63 along with the date and time of measurement, etc. The uneven wear condition data 63e represents data resulting from the inspection of the condition of uneven wear of each tire 7 transmitted from the tire inspection apparatus 20 and is collected in the storage unit 63 along with the date and time of measurement, etc.

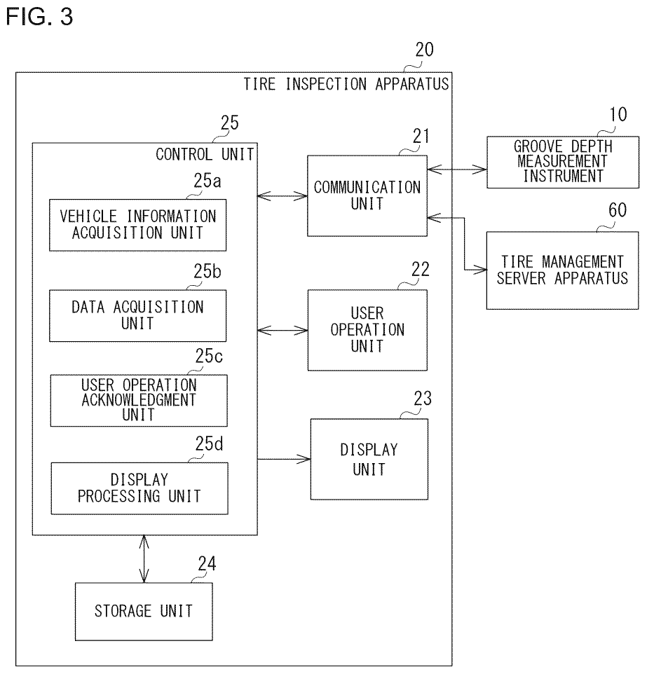

FIG. 3 is a block diagram showing a functional configuration of the tire inspection apparatus 20. The tire inspection apparatus 20 includes a communication unit 21, a user operation unit 22, a display unit 23, a storage unit 24, and a control unit 25 and is used to measure the groove depth of the tire 7 and inspect the condition of uneven wear. The tire inspection apparatus 20 acquires the data for groove depth of the tire 7 from the groove depth measurement instrument 10 and transmits the data to the tire management server apparatus 60. Further, the tire inspection apparatus 20 acquires the data for the result of inspection of the condition of uneven wear of the tire 7 and transmits the data to the tire management server apparatus 60.

The units in the tire inspection apparatus 20 can be implemented in hardware such as a processing circuit comprised of an electronic element exemplified by a CPU of a computer and a mechanical component, and in software such as a computer program. FIG. 3 depicts functional blocks implemented by the cooperation of these units. Accordingly, those skilled in the art will understand that these functional blocks can be realized in various forms by a combination of hardware and software.

The communication unit 21 is communicably connected to the communication network 8 by wireless or wired communication and communicates with the tire management server apparatus 60. Further, the communication unit 21 is communicably connected to the groove depth measurement instrument 10 by wireless or wired communication and acquires the data for groove depth of the tire 7.

The user operation unit 22 is an input apparatus that can be controlled by, for example, a touch panel, a switch, a keyboard, and a mouse. The worker manipulates the user operation unit 22 to measure the groove depth of the tire 7 and acquire the information related to the vehicle and the tire for which the condition of uneven wear is inspected from the tire management server apparatus 60.

The display unit 23 is a display apparatus such as a liquid crystal display. The display unit 23 displays the information related to axle arrangement, the groove depth data for the tire 7 being measured, the information related to the inspection of the condition of uneven wear, etc.

The storage unit 24 is a storage apparatus comprised of a solid state drive, a hard disk, a CD-ROM, a DVD, etc. The storage unit 24 stores a computer program run by the control unit 25, the axle arrangement information on the vehicle and the identification information on the tire 7 acquired from the tire management server apparatus 60, the data for groove depth of the tire 7, the information related to the inspection of the condition of uneven wear, etc.

The control unit 25 includes a vehicle information acquisition unit 25a, a data acquisition unit 25b, a user operation acknowledgment unit 25c, and a display processing unit 25d. The vehicle information acquisition unit 25a requests the tire management server apparatus 60 to transmit information on the vehicle and the tire selected in the user operation of the worker in the user operation unit 22 and acquires the axle arrangement and the identification information on the tire transmitted from the tire management server apparatus 60.

The data acquisition unit 25b acquires, for each tire 7 mounted on a given vehicle, successively measured data for groove depth from the groove depth measurement instrument 10. For a plurality of grooves extending in the circumferential direction of the tire in the tread part of a given tire 7, the data acquisition unit 25b acquires the data for groove depth measured at three locations in the circumferential direction of the same groove at an interval of, for example, 120°.

The data acquisition unit 25b successively acquires the data for groove depth of further grooves provided alongside in the tire width direction similarly measured at three locations. After the data acquisition unit 25b acquires the data for groove depth for all grooves of the given tire 7, the data acquisition unit 25b continues to acquire the data for groove depth of the respective tires in the vehicle in a similar sequence of steps.

The user operation acknowledgment unit 25c acknowledges a user operation input provided by the worker to indicate whether an uneven wear is identified in the tire 7 for which the data for groove depth is acquired by the data acquisition unit 25b. The user operation acknowledgment unit 25c displays, for example, a screen for acknowledging a user operation input indicating whether an uneven wear is identified and acknowledges a user operation input of the worker in the user operation unit 22.

The worker determines whether an uneven wear is identified by examining the tread part of the tire visually and referring to the data for groove depth acquired. The worker uses the user operation unit 22 to input a response to indicate “an uneven wear is identified” or “an uneven wear is not identified”. The user operation acknowledgment unit 25c may acknowledge a response from the worker indicating that uneven wear “has not been examined”. When the user operation input of the worker indicates “an uneven wear is identified”, the user operation acknowledgment unit 25c outputs a notification indicating “an uneven wear is identified” to the display processing unit 25d.

When a signal input from the user operation acknowledgment unit 25c indicates “an uneven wear is identified”, the display processing unit 25d causes the display unit 23 to display a schematic diagram corresponding to a plurality of types related to uneven wear. The types of uneven wear include center wear, feather edge wear, heel and toe wear, shoulder wear (one-sided wear), shoulder wear (double-sided wear), spot wear, etc. Heel and toe wear is a form of uneven wear in which the amount of wear differs between the side of a block in the tread part, divided in the circumferential direction of the tire, that is touching the ground and the side thereof that is leaving the ground, resulting in a step created between blocks.

The worker determines which uneven wear the tire being inspected corresponds to while viewing a schematic diagram corresponding to a plurality of types related to uneven wear displayed on the display unit 23 and uses the user operation unit 22 to provide a user operation input to select a type of uneven wear from the schematic diagram.

The user operation acknowledgment unit 25c acknowledges the user operation input of the worker to select a type of uneven wear by using the user operation unit 22. When the acknowledged user operation input indicates selection of heel and toe wear, the user operation acknowledgment unit 25c outputs a notification indicating that heel and toe wear is selected to the display processing unit 25d and the data acquisition unit 25b.

When a signal indicating that heel and toe wear is selected is input from the user operation acknowledgment unit 25c, the display processing unit 25d further causes the display unit 23 to display a screen for measuring a stepped wear in block in the tread part.

The data acquisition unit 25b acquires the data for groove depth corresponding to the stepped wear measured by the groove depth measurement instrument 10. The data for groove depth corresponding to the stepped wear represents data for groove depth on the side of the block in the tread part that is touching the ground and the side thereof that is leaving the ground. The data acquisition unit 25b may acquire image data for an image of the tread part of the tire 7 captured by the worker.

The control unit 25 of the tire inspection apparatus transmits the data for groove depth of each groove of all tires 7 mounted on the vehicle and the result of inspection of the condition of uneven wear of the tires 7 to the tire management server apparatus 60. The result of inspection of the condition of uneven wear is comprised of, as described above, whether an uneven wear is identified, type of uneven wear, and data for stepped wear in the case of heel and toe wear. The information processing unit 62 of the tire management server apparatus 60 collects the data for groove depth in the storage unit 63 as the tire groove depth data 63d and collects the result of inspection of the condition of uneven wear in the storage unit 63 as the uneven wear condition data 63e.

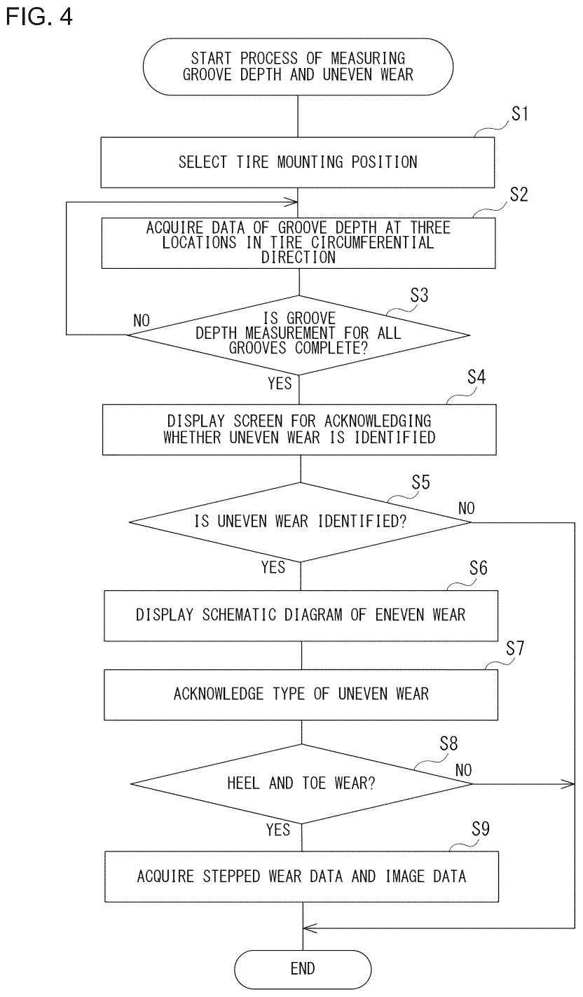

A description will now be given of the operation of the tire inspection system 100. FIG. 4 is a flowchart showing a sequence of steps of a process performed by the tire inspection system 100 to measure the groove depth and uneven wear. It is assumed that the vehicle information acquisition unit 25a of the tire inspection apparatus 20 has acquired in advance, from the tire management server apparatus 60, the axle arrangement, the tire identification information, etc. for the vehicle for which the groove depth of the tire 7 is measured. The data acquisition unit 25b of the tire inspection apparatus 20 selects the tire mounting position of the target of measurement based on the user operation of the worker in the user operation unit 22 (S1).

The data acquisition unit 25b selects one groove in the tire 7 selected in step S1 and acquires the data for groove depth measured at three locations in the circumferential direction of the tire (S2). The data for groove depth is measured by the worker by using the groove depth measurement instrument 10 and transmitted from the groove depth measurement instrument 10 to the tire inspection apparatus 20.

The data acquisition unit 25b determines whether the measurement of groove depth is completed for all grooves of the tire 7 (S3). When the measurement of groove depth is not completed (S3: NO), the data acquisition unit 25b selects the next groove and returns to step S2 to repeat the process. When it is determined in step S3 that the measurement is completed for all grooves (S3: YES), the user operation acknowledgment unit 25c causes the display unit 23 to display a screen for acknowledging a user operation input indicating whether an uneven wear is identified (S4).

The user operation acknowledgment unit 25c determines whether the user operation input provided by the worker indicates that an uneven wear is identified or not (S5). When it is determined in step S5 that the user operation input indicates that an uneven wear is not identified (S5: NO), the process is terminated. When it is determined in step S5 that the user operation input indicates that an uneven wear is identified (S5: YES), the display processing unit 25d causes the display unit 23 to display a schematic diagram corresponding to a plurality of types related to uneven wear (S6).

The user operation acknowledgment unit 25c acknowledges a user operation input of the worker to select a type of uneven wear (S7). The user operation acknowledgment unit 25c determines whether the uneven wear selected by the worker is heel and toe wear (S8). When it is determined in step S8 that the wear is not a heel and toe wear (S8: NO), the process is terminated.

When it is determined in step S8 that the wear is a heel and toe wear (S8: YES), a screen for acquiring stepped wear data is displayed on the display unit 23, and the data acquisition unit 25b acquires the stepped wear data and the image data for the tread part (S9) and terminates the process.

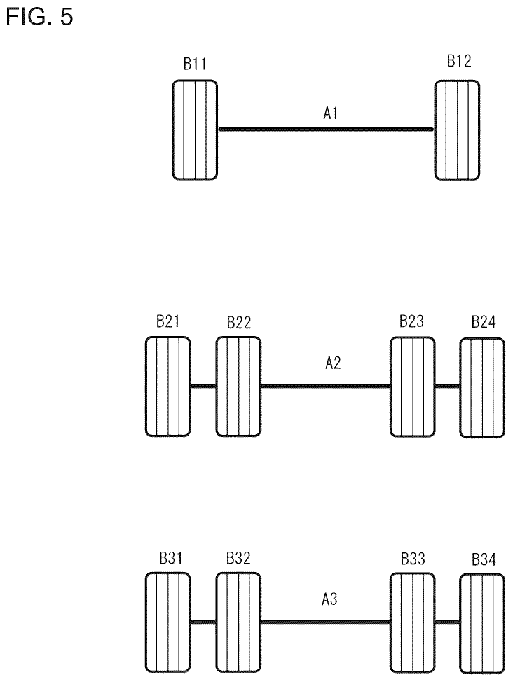

FIG. 5 is a schematic diagram showing an example of axle arrangement information 63b. The axle arrangement information 63b shown in FIG. 5 shows three axles A1, A2, and A3 in the longitudinal direction of a vehicle and tire mounting positions B11, B12, etc. in the respective axles. A total of 10 tires are arranged in the axles. The data acquisition unit 25b selects the tire mounting position subject to measurement based on the user operation of the worker in the user operation unit 22 and acquires the data for groove depth based on the flowchart shown in FIG. 4. When acquisition of all data for groove depth and of the result of inspection of the condition of uneven wear is completed for a given tire, the next tire mounting position is selected, and the data for groove depth and the result of inspection of the condition of uneven wear are acquired. By repeating these steps, the data for groove depth and the result of inspection of the condition of uneven wear are acquired for all tires mounted on the vehicle.

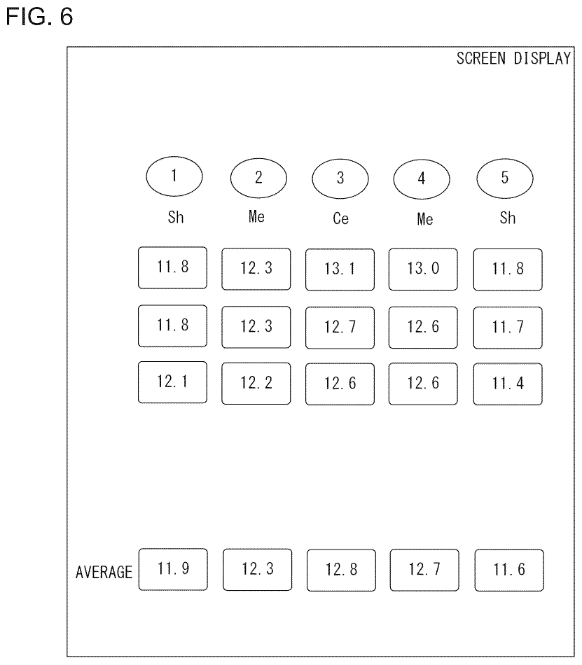

FIG. 6 is a schematic diagram showing an exemplary image displayed on the display unit 23 after a groove depth is measured. In the example shown in FIG. 6, groove 1 through groove 5 are located in a given tire 7. The position of each groove in the tire width direction is represented by Sh (shoulder), Me (medium), and Ce (center). The example shown in FIG. 6 shows the result of measurement of groove depth of groove 1 through groove 5 and average values of groove depth in the respective grooves calculated.

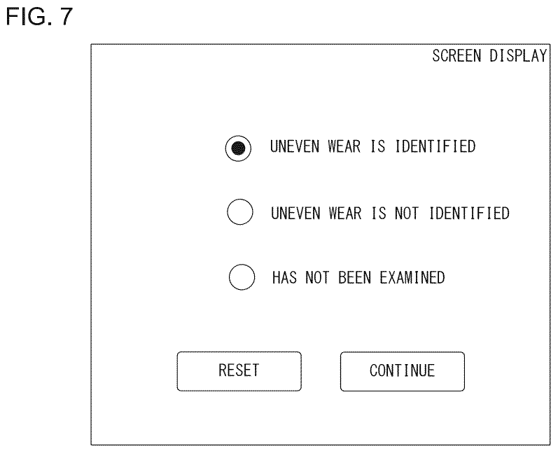

FIG. 7 shows an exemplary screen for acknowledging a user operation input indicating whether an uneven wear is identified or not. The user operation acknowledgment unit 25c causes the display unit 23 to display the screen shown in FIG. 7 and acknowledges a user operation input of the worker regarding whether an uneven wear “is identified”, “is not identified”, or “has not been examined”.

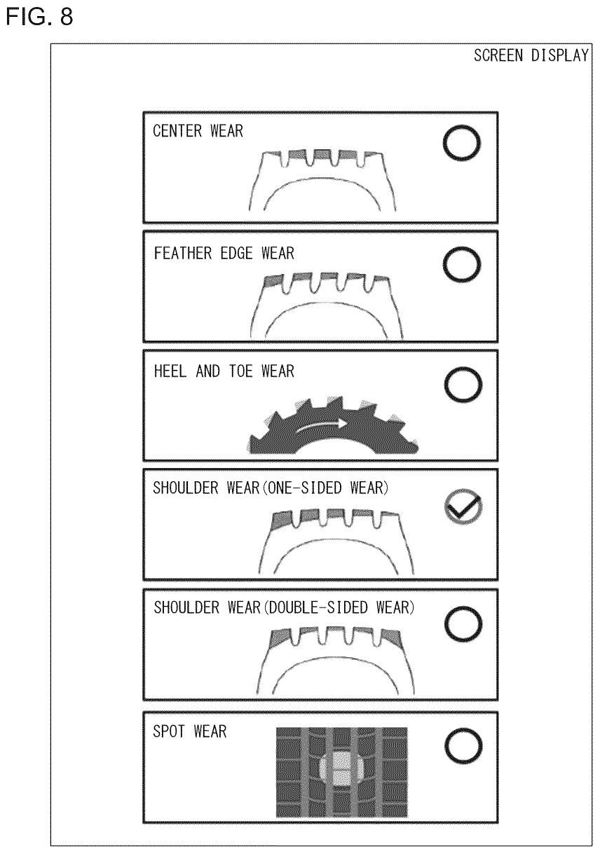

FIG. 8 shows an exemplary screen showing a schematic diagram corresponding to a plurality of types of uneven wear. When the user operation input provided by the worker indicates selection of “an uneven wear is identified”, the display processing unit displays a schematic diagram as shown in FIG. 8 corresponding to a plurality of types of uneven wear. The tire inspection system 100 is configured to display a schematic diagram corresponding to a plurality of types of uneven wear in the tire inspection apparatus 20 to enable the worker to select a type of uneven wear easily while visually examining which schematic diagram matches the appearance of the tread part of the tire 7 actually being examined and to conduct an inspection of the condition of uneven wear of the tire 7 efficiently.

If, for example, the measurement of groove depth for all tires 7 of the vehicle and the inspection, whereby the three-dimensional tire shape is read by a scanner and a determination is made by searching the uneven wear database, are separately conducted, a lot of effort and time would be required for movement of the worker and preparation of a measurement instrument, etc. The tire inspection system 100 allows a work to proceed such that measurement of groove depth and inspection of uneven wear are successively conducted for a given tire 7 and allows efficiently conducting inspection of the condition of uneven wear, including measurement of groove depth of the tire 7.

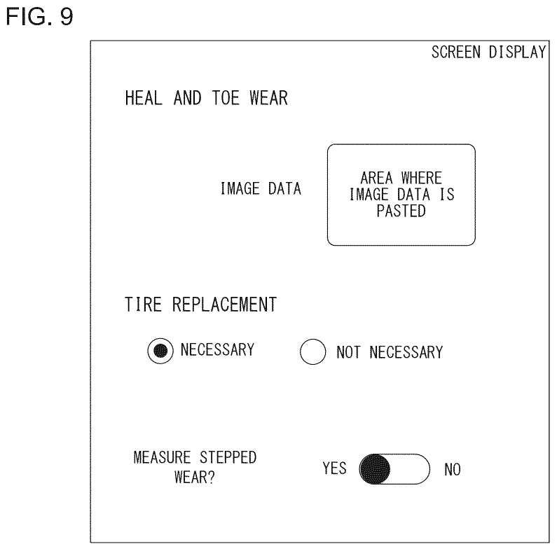

FIG. 9 shows an exemplary screen shown when heel and toe wear is selected. In the screen shown in FIG. 9, a graphic indicating an area where image data capturing the appearance of the tread part is pasted, a graphic prompting selection of whether tire exchange is necessary or unnecessary, a graphic prompting selection of whether to measure a stepped wear or not, etc.

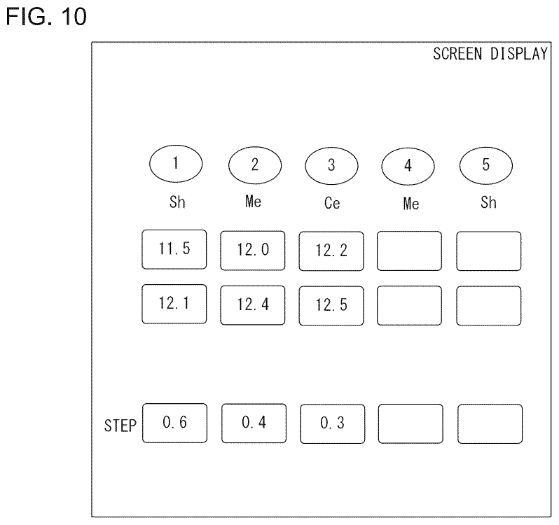

By using the data acquisition unit 25b to acquire image data capturing the appearance of the tread part of the tire 7, the tire inspection system 100 can store and collect the condition of heel and toe wear in the actual tire 7 in the form of data easy to understand visually. A graphic indicating an area where image data is pasted may be provided in the screen display shown in FIG. 10 described later, and image data capturing the appearance of the tread part of the tire 7 may be acquired.

FIG. 10 shows an example of screen display for acquiring stepped wear data. In the screen display shown in FIG. 10, as in the case of FIG. 6, the stepped wear data for groove 1 through groove 5 of a given tire 7 is successively acquired and displayed. The data acquisition unit 25b acquires, in the form of stepped wear data, the data for groove on the side of the block in the tread part that is touching the ground and the side thereof that is leaving the ground.

By using the data acquisition unit 25b to acquire and collect the stepped wear data in the block in the tread part of tire 7, the tire inspection system 100 can let the worker know the condition of advancement of heel and toe wear in an easy-to-understand manner and provide data necessary for determination on tire maintenance.

A description will now be given of the feature of the tire inspection system 100 and the tire inspection program according to the embodiment. The tire inspection system 100 includes the data acquisition unit 25b, the user operation acknowledgment unit 25c, and the display processing unit 25d. The data acquisition unit 25b acquires the data for groove depth measured by the groove depth measurement instrument 10 for measuring the groove depth of the tire 7. The user operation acknowledgment unit 25c acknowledges a user operation input provided by the worker to indicate whether an uneven wear is identified in the tire 7 for which the data for groove depth is acquired by the data acquisition unit 25b. When the user operation input acknowledged by the user operation acknowledgment unit 25c indicates that an uneven wear is identified, the display processing unit 25d displays a schematic diagram corresponding to a plurality of types of uneven wear. The user operation acknowledgment unit 25c acknowledges a user operation input for the worker's selection of a type of uneven wear from the schematic diagram. This allows the tire inspection system 100 to conduct an inspection of the condition of uneven wear of the tire 7 efficiently.

When the type of uneven wear selected in the user operation input acknowledged by the user operation acknowledgment unit 25c is heel and toe wear, the data acquisition unit 25b further acquires data for stepped wear of the block in the tread part. This allows the tire inspection system 100 to let the worker know the condition of advancement of heel and toe wear in an easy-to-understand manner and provide data necessary for determination on tire maintenance.

Further, the data acquisition unit 25b acquires image data capturing the tread part of the tire 7. This allows the tire inspection system 100 to collect the condition of heel and toe wear in the form of data easy to understand visually.

A tire inspection program on a non-volatile recording medium for tire inspection encoded with the program causes a computer to execute a data acquisition step, a user operation acknowledgment step, and a display processing step. The data acquisition unit step acquires the data for groove depth measured by the groove depth measurement instrument 10 for measuring the groove depth of the tire 7. The user operation acknowledgment step acknowledges a user operation input provided by the worker to indicate whether an uneven wear is identified in the tire 7 for which the data for groove depth is acquired by the data acquisition step. When the user operation input acknowledged by the user operation acknowledgment step indicates that an uneven wear is identified, the display processing step displays a schematic diagram corresponding to a plurality of types of uneven wear. The user operation acknowledgment step acknowledges a user operation input for the worker's selection of a type of uneven wear from the schematic diagram. According to this tire inspection program, it is possible to conduct an inspection of the condition of uneven wear of the tire 7 efficiently.

Described above is an explanation based on an exemplary embodiment. The embodiments are intended to be illustrative only and it will be understood by those skilled in the art that variations and modifications are possible within the claim scope of the present invention and that such variations and modifications are also within the claim scope of the present invention. Therefore, the description in this specification and the drawings shall be treated to serve illustrative purposes and shall not limit the scope of the invention.

What is claimed is:

1. A tire inspection apparatus comprising:
a data acquisition unit that acquires, from a groove depth measurement instrument, data for groove depth of a tire mounted on a vehicle;
a user operation acknowledgment unit that acknowledges a user operation input indicating whether an uneven wear is identified in the tire for which the data for groove depth is acquired; and
a display processing unit that provides, when the user operation acknowledgment unit acknowledges that an uneven wear is identified, a schematic diagram corresponding to at least one uneven wear, wherein
the user operation acknowledgment unit is configured to acknowledge a user operation input to select an uneven wear from the schematic diagram.

2. The tire inspection apparatus according to claim 1, wherein
the data acquisition unit is configured to acquire, when the user operation input acknowledged by the user operation acknowledgment unit indicates selection of heel and toe wear, data for wear of the heel and toe edges of blocks in a tread part.

3. The tire inspection apparatus according to claim 1, wherein
when the user operation input acknowledged by the user operation acknowledgment unit indicates selection of heel and toe wear, the display processing unit displays an input window for inputting a stepped wear of a block of a tread part.

4. The tire inspection apparatus according to claim 1, wherein
the data acquisition unit is configured to acquire image data capturing a tread part of the tire.

5. The tire inspection apparatus according to claim 1, wherein
the user operation acknowledgment unit acknowledges a user operation input indicating whether the tire needs to be exchanged.

6. The tire inspection apparatus according to claim 1, wherein
types of uneven wear include at least two of center wear, feather edge wear, heel and toe wear, and shoulder wear.

7. The tire inspection apparatus according to claim 1, wherein
the vehicle is a vehicle operated under management of a transport company.

8. The tire inspection apparatus according to claim 1 further comprising:
a vehicle information acquisition unit that acquires axle arrangement information on the vehicle from an external apparatus, wherein
the axle arrangement information includes information related to a position of an axle and the tire of the vehicle.

9. The tire inspection apparatus according to claim 8, wherein
when acquisition of a result of inspection of a condition of uneven wear is completed for a given tire of a vehicle, a next tire mounting position is selected and a result of inspection of a condition of uneven wear of the tire is acquired based on the axle arrangement information.

10. A tire inspection system comprising:
a tire management server apparatus comprising:
a storage unit that stores axle arrangement information including information related to a position of an axle and a tire of a vehicle; and
an information processing unit that reads the axle arrangement information from the storage unit and transmits the axle arrangement information; and
a tire inspection apparatus comprising:
a vehicle information acquisition unit that acquires the axle arrangement information on the vehicle from the tire management server apparatus;
a data acquisition unit that acquires, from a groove depth measurement instrument, data for groove depth of a tire mounted on the vehicle based on the axle arrangement information;
a user operation acknowledgment unit that acknowledges a user operation input indicating whether an uneven wear is identified in the tire for which the data for groove depth is acquired; and
a display processing unit that provides, when the user operation acknowledgment unit acknowledges that an uneven wear is identified, a schematic diagram corresponding to at least one uneven wear, wherein
the user operation acknowledgment unit is configured to acknowledge a user operation input to select an uneven wear from the schematic diagram.

11. The tire inspection system according to claim 10, wherein
the data acquisition unit is configured to acquire, when the user operation input acknowledged by the user operation acknowledgment unit indicates selection of heel and toe wear, data for wear of the heel and toe edges of blocks in a tread part.

12. The tire inspection system according to claim 10, wherein
when the user operation input acknowledged by the user operation acknowledgment unit indicates selection of heel and toe wear, the display processing unit displays an input window for inputting a stepped wear of a block of a tread part.

13. The tire inspection system according to claim 10, wherein
the data acquisition unit is configured to acquire image data capturing a tread part of the tire.

14. The tire inspection system according to claim 10, wherein
the user operation acknowledgment unit acknowledges a user operation input indicating whether the tire needs to be exchanged.

15. The tire inspection system according to claim 10, wherein
types of uneven wear include at least two of center wear, feather edge wear, heel and toe wear, and shoulder wear.

16. The tire inspection system according to claim 10, wherein
the vehicle is a vehicle operated under management of a transport company.

17. The tire inspection apparatus according to claim 10, wherein
when acquisition of a result of inspection of a condition of uneven wear is completed for a given tire of a vehicle, the tire inspection apparatus selects a next tire mounting position and acquires a result of inspection of a condition of uneven wear of the tire based on the axle arrangement information.

18. A non-volatile recording medium for tire inspection encoded with a program, the program comprising computer-implemented modules including:
a data acquisition module that acquires data for groove depth of a tire from a groove depth measurement instrument;
a user operation acknowledgment module that acknowledges a user operation input indicating whether an uneven wear is identified in the tire for which the data for groove depth is acquired; and
a display processing module that provides, when the user operation acknowledgment module acknowledges that an uneven wear is identified, a schematic diagram corresponding to at least one uneven wear, wherein
the user operation acknowledgment step is configured to acknowledge a user operation input to select an uneven wear from the schematic diagram.
